(19) United States
(12) Patent Application Publication
(10) Pub. No.: US 2006/0081354 A1
(43) Pub. Date: Apr. 20, 2006

(54) Radiator core support structure

(75) Inventors: Satoru Miura, Tokyo (JP); Toshihide Furukawa, Tokyo (JP); Tadahiro Hirai, Tokyo (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/244,404

(22) Filed: Oct. 6, 2005

(30) Foreign Application Priority Data
Oct. 8, 2004 (JP) 2004-296861

(51) Int. Cl. B60H 1/00; F28F 9/00; B60K 11/04

(52) U.S. Cl. 165/41; 165/67; 180/68.4

(57) ABSTRACT

A radiator core support has a lower radiator core support extending in a lateral direction of a vehicle body, radiator core support sides extending upward respectively from both end portions of the lower radiator core support, a fan shroud portion provided inside the lower radiator core support and both the radiator core support sides, and a radiator core support upper cover provided to cover at least an upper side between both the radiator core support sides. The lower radiator core support, both the radiator core support sides, and the fan shroud portion are formed integrally, and the radiator core support upper cover is fixed detachably with respect to the lower radiator core support, both the radiator core support sides, and the fan shroud portion.

### BACKGROUND OF THE INVENTION

1. Field of the Invention

The present invention relates to a radiator core support structure for mounting a heat exchanger on a motor vehicle.

2. Description of the Related Art

Hitherto, a radiator core support structure for a motor vehicle is described in Japanese Patent Application Laid-open No. 2003-81135, which has an upper radiator core support extending in a lateral direction of a motor vehicle body, a lower radiator core support extending in parallel with the upper radiator core support, radiator core support sides fixing both end portions of the upper radiator core support and the lower radiator core support to each other, and a hood lock stay fixing center portions of the upper radiator core support and the lower radiator core support to each other.

Also, Japanese Patent Application Laid-open No. 2002-19638 discloses a technology on a radiator core support of a type in which the upper radiator core support is omitted from the first conventional structure described above. However, in the former conventional radiator core support structure, when the heat exchanger is attached to the radiator core support by inserting it between both the radiator core support sides from an upper side, the heat exchanger comes in contact with the upper radiator core support, becoming an obstacle to its insertion, so that the heat exchanger needs to be fixed in such a way that, after it is inserted between both the radiator core support sides from an obliquely upper side and then its lower portion is fixed to the lower radiator core support, the heat exchanger is raised to stand upright and its upper portion is fixed to the upper radiator core support. This causes a problem of requiring a lot of labor for attachment as well as a large working space. Also, in the latter radiator core support structure, with the upper radiator core support, which is the obstacle to the insertion, being omitted, the heat exchanger can be inserted and fixed between both the radiator core support sides from the upper side of the radiator core support, but the overall stiffness of the radiator core support decreases, so that each part thereof needs to be formed with a large thickness to increase their stiffness. This causes a problem of increasing weight and a manufacturing cost.

Note that, since impact force generated in the event of a light crash of a motor vehicle acts on the radiator core support so as to open outward in the lateral direction of the vehicle body, the upper radiator core support serves as a beam member to prevent deformation of both the radiator core support sides outward in the lateral direction. However, since radiator core supports of recent years are formed integrally using resin or metal, they require a lot of labor and cost to be repaired or replaced.

The present invention is made to solve the above-described problems, and an object thereof is to provide a radiator core support structure which can provide excellent workability for mounting a heat exchanger on a radiator core support without causing decrease of the overall stiffness of the radiator core support.

### SUMMARY OF THE INVENTION

A radiator core support structure according to the present invention includes a lower radiator core support extending in a lateral direction of a motor vehicle body, radiator core support sides extending upward respectively from both end portions of the lower radiator core support, a fan shroud portion provided inside the lower radiator core support and both the radiator core support sides, and a radiator core support upper cover provided to cover at least an upper side between both the radiator core support sides, wherein the lower radiator core support, both the radiator core support sides, and the fan shroud portion are formed integrally, and the radiator core support upper cover is fixed detachably at least on upper portions of the radiator core support sides.

Therefore, when the heat exchanger is assembled, the heat exchanger is inserted from an upper side between both the radiator core support sides and attached thereto in a state that the radiator core support upper cover is removed, and the radiator core support upper cover can be attached thereafter. Accordingly, the heat exchanger can be attached to the radiator core support simply within a small working space, because the heat changer does not need to be slanted when it is inserted between both the radiator core support sides.

Further, the overall stiffness of the radiator core support can be improved by the fan shroud portion and the radiator core support upper cover, and particularly, it is possible to prevent, in the event of a light crash of a motor vehicle, deformation of both the radiator core support sides to open outward in the vehicle width direction to thereby cause a crack/damage.

Moreover, by providing the radiator core support upper cover in a detachable manner, an operation of repairing or replacing the heat exchanger can be easily performed.

Preferably, the radiator core support structure further comprises a detachable hood lock stay fixing center portions of the radiator core support upper cover and the lower radiator core support to each other.

Therefore, impact force in the event of light crash of a motor acts is transferred to both the radiator core support sides through the hood lock stay, so that damaged portions are stopped at the hood lock stay or the radiator core support upper cover, which enables them to be easily replaced for repair, thus suppressing cost of repairing or replacing low.

Preferably, the radiator core support upper cover is fixed detachably on an upper portion of the fan shroud portion.

Therefore, the radiator core support upper cover can be stably fixed to the fan shroud portion, and thereby increase the overall stiffness of the radiator core support.

Preferably, the radiator core support upper cover is fixed to the fan shroud portion and the radiator core support sides.

Therefore, the radiator core support upper cover can be stably fixed to the fan shroud portion and the radiator core support sides, and thereby increase the overall stiffness of the radiator core support.

Preferably, the radiator core support upper cover is fixed to the fan shroud portion and the radiator core support sides. Preferably, the radiator core support upper cover is formed with attachment holes to fix mounting pins of the heat exchanger, and provided on a bottom face thereof with sandwiching portions to sandwich and fix tongue pieces of the fan shroud portion in a forward and back ward direction thereof

Therefore, both the heat exchanger and the radiator core support cover can be appropriately fixed in a positioned state.

### BRIEF DESCRIPTION OF THE DRAWINGS

The objects, features and advantages of the present invention will become apparent as the description proceeds when taken in conjunction with the accompanying drawings, in which:

FIG. 1 is an exploded overall perspective view showing a radiator core support structure of an embodiment according to the present invention;

FIG. 2 is an overall perspective view showing the radiator core support structure of the embodiment;

FIG. 3 is a perspective view showing a radiator core support used in the radiator core support structure shown in FIGS. 1 and 2;

FIG. 4 is a perspective view showing a radiator core support upper cover used in the radiator core support shown in FIG. 3;

FIG. 5 is a perspective view showing a hood lock stay used in the radiator core support shown in FIG. 3;

FIG. 6 is a view explaining how to mount a heat exchanger on the radiator core support shown in FIGS. 1 to 3;

FIG. 7A is a view explaining how to fix a radiator core support upper cover to radiator core support sides used in the radiator core support shown in FIG. 3, and

FIG. 7B is an enlarged view of a circle portion indicated by B in FIG. 7A; and

FIG. 8 is a view explaining how to fix the hood lock stay to radiator core support sides used in the radiator core support shown in FIG. 3.

### DETAILED DESCRIPTION OF THE PREFERRED EMBODIMENTS

Hereinafter, an embodiment of the present invention will be described with reference to the accompanying drawings.

Hereinafter, an embodiment will be explained. First, the entire structure of a radiator core support structure for a motor vehicle will be described.

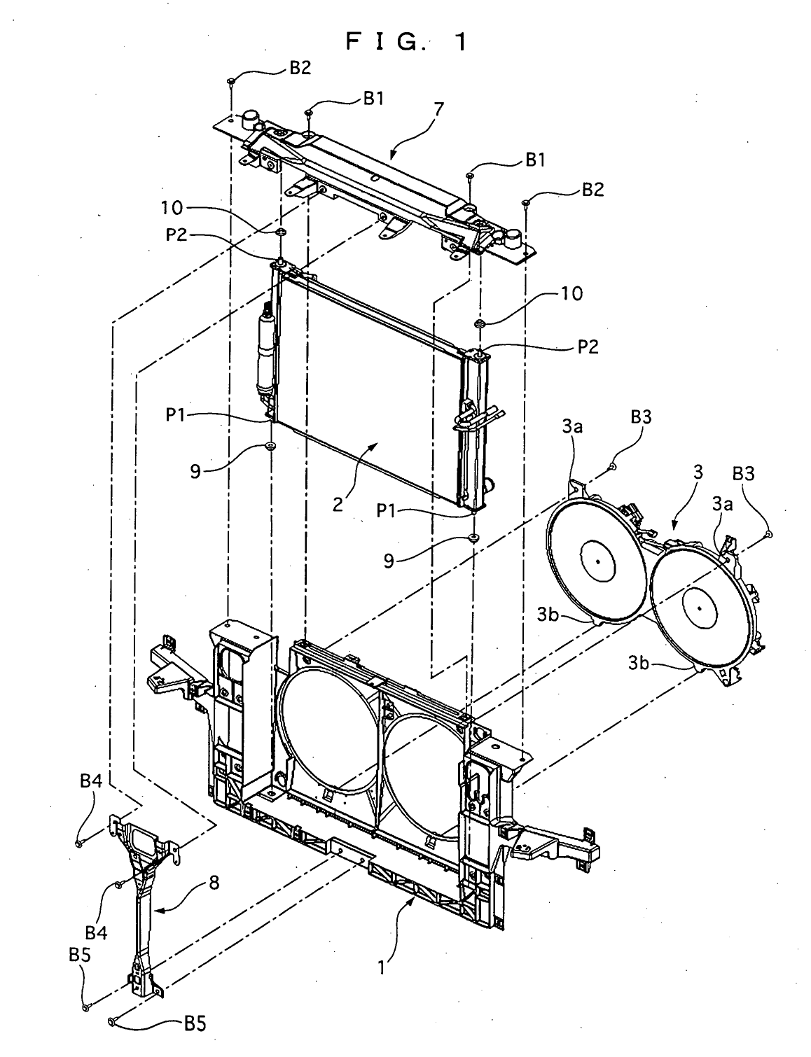

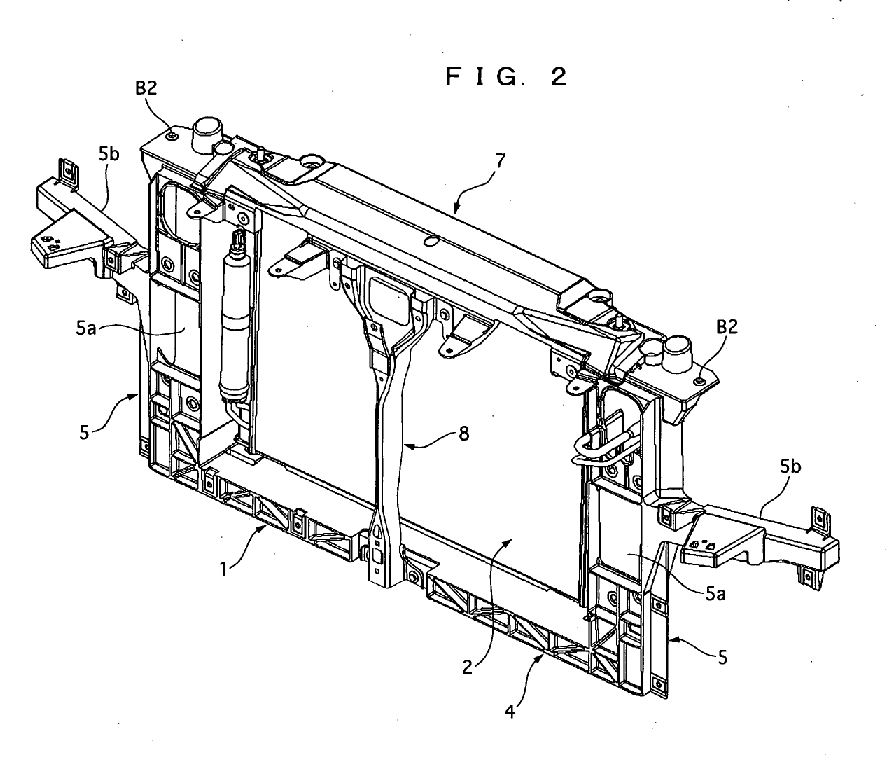

As shown in FIG. 1 and FIG. 2, the radiator core support structure of this embodiment has a radiator core support 1 mounted on a front side of a vehicle body, a heat exchanger 2 for cooling coolant and cooling medium, and a motor fan 3 for cooling the heat exchanger 3. The heat exchanger 2 and the motor fan 3 are fixed to the radiator core support 1, which will be described below in detail.

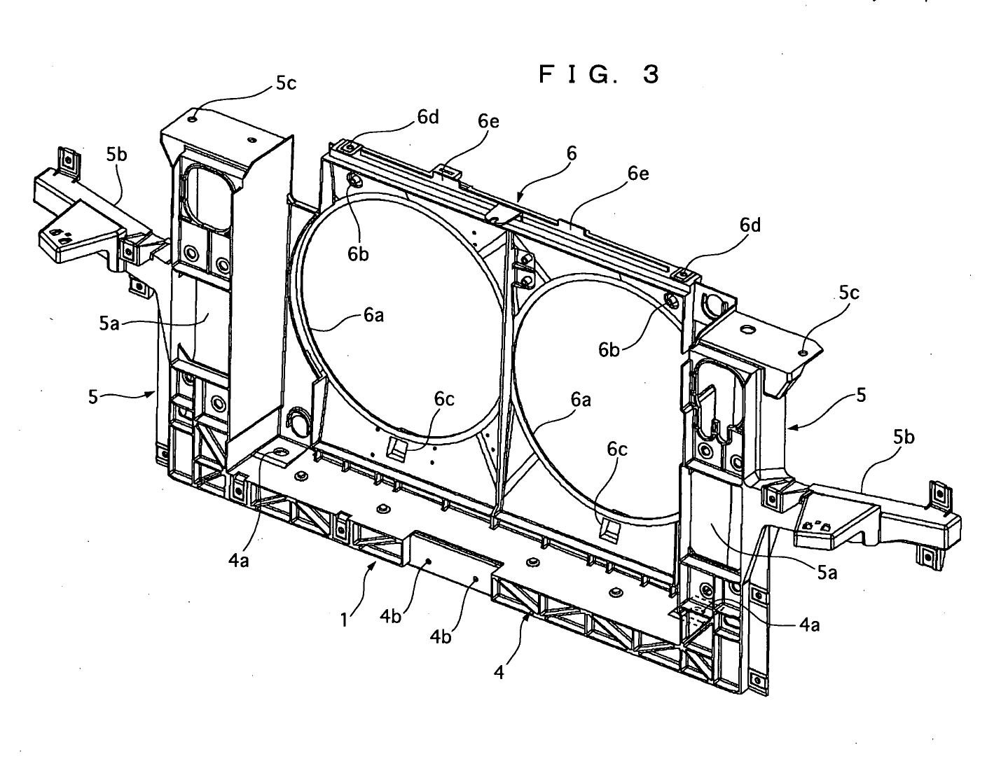

As shown in FIG. 3, the radiator core support 1 has a lower radiator core support 4 extending in a lateral direction of the vehicle body, two radiator core support sides 5 and 5 extending upward respectively from both end portions of the lower radiator core support, and a fan shroud portion 6 provided inside the lower radiator core support 4 and both the radiator core support sides 5 and 5. The lower radiator core support 4, the radiator core support sides 5 and 5 and the fan shroud portion 6 are integrally formed of resin.

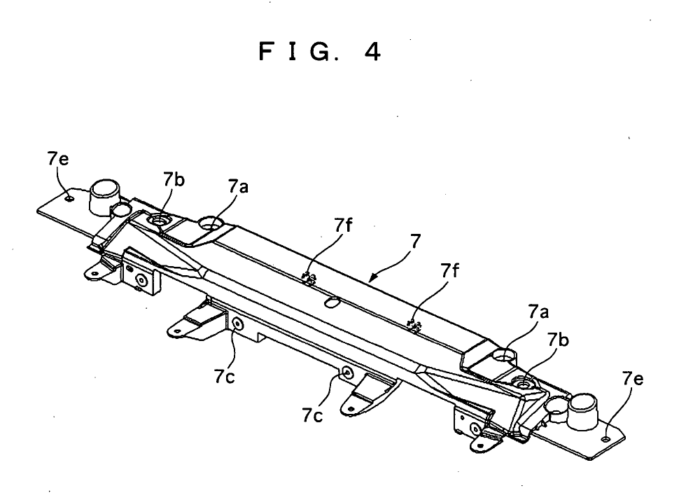

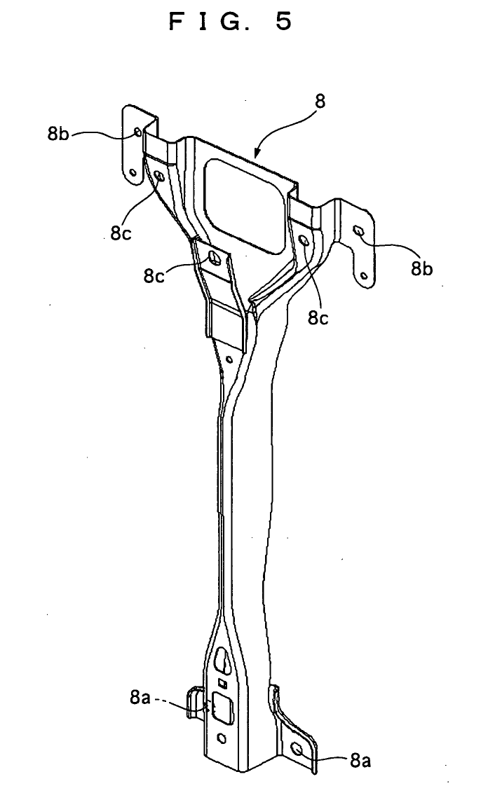

Further, a radiator core support upper cover 7 shown in FIG. 4 is provided so as to couple both the radiator core support sides 5 and 5 to each other, and a hood lock stay 8 shown in FIG. 5 is provided so as to couple center portions of the radiator core support upper cover 7 and the lower radiator core support 4 to each other.

The lower radiator core support 4 is formed to have a cross-section in shape of a letter of L or the like opening downward and rearward, and on a top face thereof, two attachment holes 4a and 4a are formed at positions corresponding to mounting pins P1 and P1, shown in FIG. 1, provided respectively on both ends of a lower side of the heat exchanger 2.

Further, on a front side face of the lower radiator core support 4, two attachment holes 4b and 4b are formed at positions corresponding to attachment holes 8a and 8a of a lower portion of the hood lock stay 8.

The radiator core support sides 5 and 5 are formed to have a cross section in a shape of a letter of C or the like opening rearward, and two side member attachment holes 5a and 5a for coupling not-shown side members and bumper stays are formed respectively therein.

Two head lamp stays 5b and 5b for fixing and supporting not-shown head lamps are formed respectively in the vicinities of the side member attachment holes 5a and 5a in a state of projecting outward in the lateral direction.

Moreover, on top faces of both the radiator core support sides 5 and 5, two attachment holes 5c and 5c are formed at positions corresponding to attachment holes 7e and 7e of the radiator core support upper cover 7.

The fan shroud portion 6 is formed integrally with and inside of the lower radiator core support 4 and both the radiator core support sides 5 and 5, thereby increasing the overall stiffness of the radiator core support 1.

Further, on left and right sides of the center of the fan shroud portion 6, two openings 6a and 6a for accommodating a motor fan 3 are formed, and above the openings 6a and 6a, two attachment holes 6b and 6b are formed at positions corresponding to attachment holes 3a and 3a of the motor fan 3 as shown in FIG. 1. On the other hand, below the openings 6a and 6a, two attachment holes 6c are 6c are formed at positions corresponding to inserting projections 3b and 3b of the motor fan 3 as shown in FIG. 1.

Further, on an upper portion of the fan shroud portion 6, two attachment holes 6d and 6d are formed at positions corresponding to attachment holes 7a and 7a of the radiator core support upper cover 7, and also two tongue pieces 6e and 6e projecting upward in a plate shape are formed at positions corresponding to sandwiching portions 7f and 7f constituted of two pieces formed on a bottom face of the radiator core support upper cover 7.

The radiator core support upper cover 7 has a main purpose of improving the design inside an engine room as well as preventing blowing back of hot air to the front side of the heat exchanger, and is formed of resin in a plate shape. On a top face of the radiator core support upper cover 7, the attachment holes 7a and 7a and the attachment holes 7e and 7e are formed, and two attachment holes 7b and 7b are formed at positions corresponding to mounting pins P2 and P2, as shown in FIG. 1, provided respectively on both ends of an upper side of the heat exchanger 2.

Further, on a front side face of the radiator core support upper cover 7, two attachment holes 7c and 7c are formed at positions corresponding to attachment holes 8b and 8b on an upper portion of the hood lock stay 8. Further, on a rear face of the radiator core support upper cover 7, the sandwiching portions 7f and 7f are formed.

The hood lock stay 8 is formed by press forming a metal plate, and on the upper portion thereof, the attachment holes 8b and 8b are formed, and three attachment holes 8c for fixing a not-shown hood lock stay are formed.

Further, two attachment holes 8a are 8a are formed on a lower portion of the hood lock stay 8.

As the heat exchanger 2 of this embodiment, there is adopted an integral-type heat exchanger formed integrally of a condenser core and a radiator core, which are arranged closely.

Next, the operations of the radiator core support structure will be described.

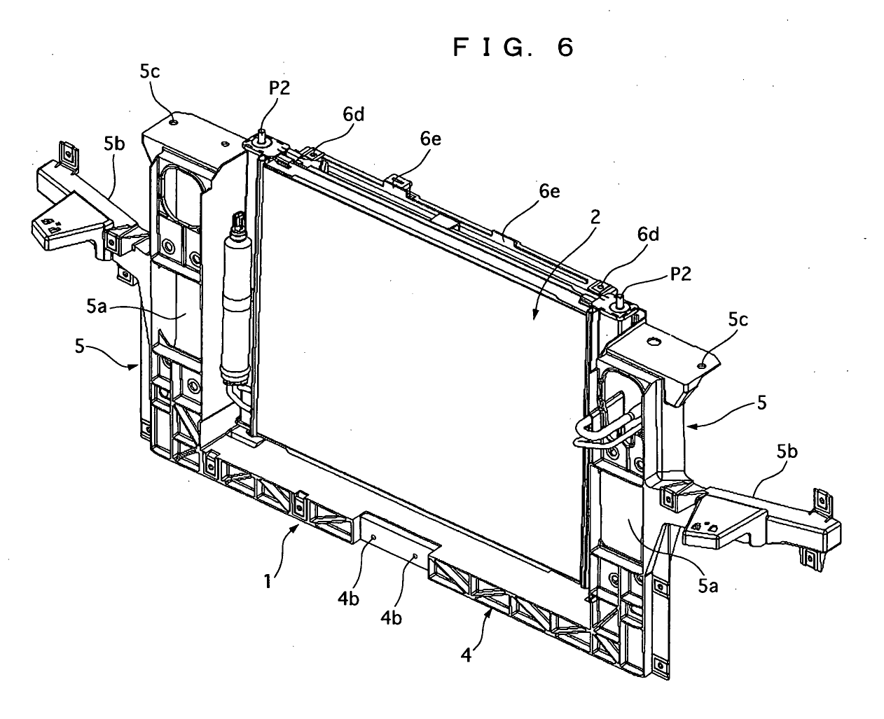

When assembling a radiator core support structure, as shown in FIG. 1 and FIG. 6, the heat exchanger 2 is inserted in an upright state thereof from a top side between both the radiator core support sides 5 and 5, and the mounting pins P1 and P1 being inserted into lower mount bushes 9 are 9 are fixed to the attachment holes 4a and 4a of the lower radiator core support 4.

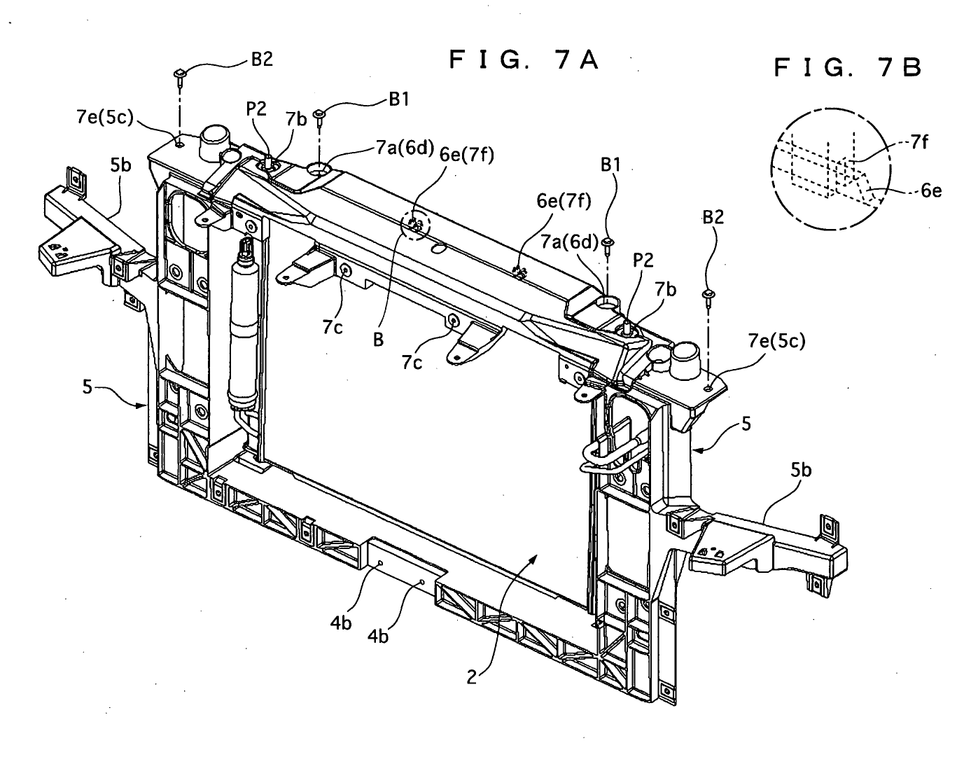

Next, as shown in FIG. 1 and FIG. 7, in a state that the mounting pins P2 and P2 of the heat exchanger are inserted into upper mount bushes 10 and 10, the radiator core support upper cover 7 is placed from an upper side thereof, thereby fixing the mounting pins P2 and P2 in the attachment holes 7b and 7b of the radiator core support upper cover 7 via the upper mount bushes 10 and 10.

Next, screws B1 are B1 are inserted through the attachment holes 7a and 7a of the radiator core support upper cover 7 and the attachment holes 6d and 6d of the fan shroud portion and fixed therein, and screws B2 and B2 are inserted through the attachment holes 7e and 7e of the radiator core support upper cover 7 and the attachment holes 5c and 5c of both the radiator core support sides 5 and 5 and fixed therein, thereby mounting the radiator core support upper cover 7 and the heat exchanger 2 on the radiator core support 1.

At this time, the attachment holes 7b and 7b of the radiator core support upper cover 7 fix the mounting pins P2 and P2 of the heat exchanger 2, and the two sandwiching portions 7f and 7f on the bottom face of the radiator core support upper cover 7 sandwich and fix the tongue pieces 6e and 6e of the fan shroud portion 6 in a forward and backward direction of the vehicle body respectively, so that both the heat exchanger 2 and the radiator core support upper cover 7 can be appropriately fixed in a positioned state.

Therefore, it is not necessary to insert the heat exchanger 2 in a slanted state from an obliquely upper side between both the radiator core support sides 5 and 5 and raise it upright thereafter as in the above-described former prior invention, so that the heat exchanger 2 can be simply and appropriately attached within a small working space, which also enables automatic assembly by machine.

Next, after the inserting projections 3b and 3b of the motor fan 3 are inserted into the attachment holes 6c and 6c of the fan shroud portion 6, screws B3 and B3 are inserted through the insertion holes 6b and 6b of the fan shroud portion 6 and the attachment holes 3a and 3a of the motor fan 3 and fixed therein, thereby mounting the motor fan 3 on the radiator core support 1.

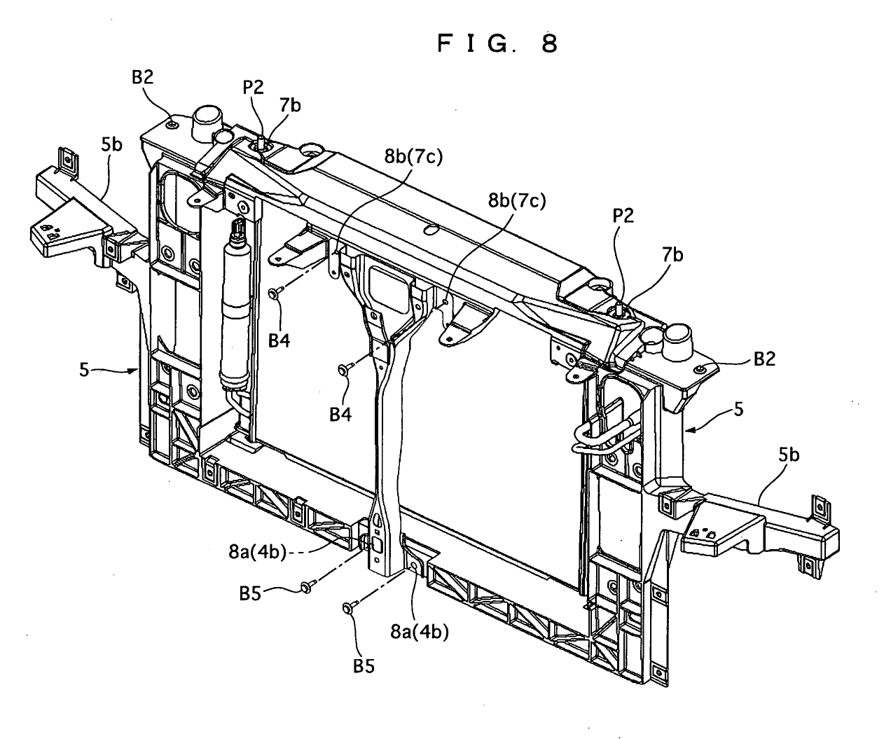

Next, as shown in FIG. 1 and FIG. 8, screws B4 and B4 are inserted through the attachment holes 8b and 8b of the hood lock stay 8 and the attachment holes 7c and 7c of the radiator core support upper cover 7 and fixed therein, and screws B5 and B5 are inserted through the attachment holes 8a and 8a of the hood lock stay 8 and the attachment holes 4b and 4b of the lower radiator core support 4 and fixed therein, thereby fixing the hood lock stay 8 onto the radiator core support 1 and completing the assembly of the radiator core support 1 as shown in FIG. 2.

The radiator core support 1 constructed as above is, after not-shown peripheral members such as head lamps, a bumper stay, a bumper armature, and the others are attached, transported to an assembly factory of motor vehicles and mounted on a motor vehicle.

In the event of a light crash of a motor vehicle, an impact force thereof acts on both the radiator core support sides 5 and 5 so as to open outward in the lateral direction of the vehicle body, but the fan shroud portion 6 formed integrally with and inside of both the radiator core support sides 5 and 5 and the lower radiator core support 4 and the radiator core support upper cover 7 coupled to the both of them serve as a beam member to prevent deformation of both the radiator core support sides 5 and 5 outward in the vehicle width direction. Therefore, a crack/damage on the radiator core support 1 can be prevented.

Also, the impact force transferred to the hood lock stay 8 can always be transferred to both the radiator core support sides 5 and 5 and the fan shroud portion 6 via the radiator core support upper cover 7, so that damaged portions are stopped at the hood lock stay 8 or the radiator core support upper cover 7 and thus the cost of fixing or replacing can be suppressed low.

Moreover, since the radiator core support upper cover 7 and the hood lock stay 8 are detachable from the radiator core support 1, maintainability inside the engine room is improved, and particularly, an operation of repairing or replacing the heat exchanger becomes simpler.

Next, the effects of the radiator core support structure of the embodiment will be described.

In the radiator core support structure constructed as above, when the heat exchanger 2 is assembled, the heat exchanger 2 is inserted from an upper side between both the radiator core support sides 5 and 5 and attached thereto in a state that the radiator core support upper cover 7 is removed, and the radiator core support upper cover 7 can be attached thereafter. Accordingly, the heat exchanger 2 can be attached to the radiator core support 1 simply within a small working space.

Also, as compared to the prior inventions, the fan shroud portion 6 and the radiator core support upper cover 7 can improve the overall stiffness of the radiator core support while omitting an upper radiator core support, and particularly, deformation of both the radiator core support sides 5 and 5 outward in the lateral direction in the event of a light crash of a motor vehicle can be prevented.

In addition, since the center portions of the radiator core support upper cover 7 and the lower radiator core support are fixed to each other by the detachable hood lock stay 8, impact force in the event of a light crash of a motor vehicle can always be transferred from the hood lock stay 8 to the vehicle body side via the radiator core support upper cover 7, which minimizes damaged portions and thus the cost of repairing or replacing can be suppressed low.

Moreover, by providing the radiator core support upper cover 7 in a detachable manner, an operation of repairing or replacing the heat exchanger 2 can be easily performed.

Also, since the radiator core support upper cover 7 and the upper portion of the fan shroud portion 6 are fixed to each other, the radiator core support upper cover 7 can be fixed stably, and moreover the overall stiffness of the radiator core support 1 can be improved.

The embodiment has been described above, but the present invention is not limited to the above-described embodiment, and any design modification and so on without departing from the spirit of the present invention will be embraced in the present invention.

For example, shapes and materials of the hood lock stay 8 and the radiator core support upper cover 7 can be determined appropriately.

The entire contents of Japanese Patent Application (Tokugan) No. 2004-26146 filed Oct. 8, 2004 is incorporated herein by reference.

What is claimed is:

1. A radiator core support structure comprising:
a lower radiator core support extending in a lateral direction of a motor vehicle body;
radiator core support sides extending upward respectively from both end portions of said lower radiator core support;
a fan shroud portion provided inside said lower radiator core support and both said radiator core support sides; and
a radiator core support upper cover provided to cover at least an upper side between both said radiator core support sides, wherein
said lower radiator core support, both said radiator core support sides, and said fan shroud portion are formed integrally, and
said radiator core support upper cover is fixed detachably at least on upper portions of said radiator core support sides.

2. The radiator core support structure according to claim 1, further comprising:
a detachable hood lock stay fixing center portions of said radiator core support upper cover and said lower radiator core support to each other.

3. The radiator core support structure according to claim 2, wherein
said radiator core support upper cover is fixed detachably on an upper portion of said fan shroud portion.

4. The radiator core support structure according to claim 2, wherein
said radiator core support upper cover is fixed to said fan shroud portion and the radiator core support sides.

5. The radiator core support structure according to claim 4, wherein
said radiator core support upper cover is formed with attachment holes to fix mounting pins of said heat exchanger, and provided on a bottom face thereof with sandwiching portions to sandwich and fix tongue pieces of said fan shroud portion in a forward and back ward direction thereof.

6. The radiator core support structure according to claim 1, wherein
said radiator core support upper cover is fixed detachably on an upper portion of said fan shroud portion.

7. The radiator core support structure according to claim 6, wherein
said radiator core support upper cover is fixed to said fan shroud portion and the radiator core support sides.

8. The radiator core support structure according to claim 7, wherein
said radiator core support upper cover is formed with attachment holes to fix mounting pins of said heat exchanger, and provided on a bottom face thereof with sandwiching portions to sandwich and fix tongue pieces of said fan shroud portion in a forward and back ward direction thereof.

9. The radiator core support structure according to claim 1,
said radiator core support upper cover is fixed to said fan shroud portion and the radiator core support sides.

10. The radiator core support structure according to claim 9, wherein
said radiator core support upper cover is formed with attachment holes to fix mounting pins of said heat exchanger, and provided on a bottom face thereof with sandwiching portions to sandwich and fix tongue pieces of said fan shroud portion in a forward and back ward direction thereof.

11. The radiator core support structure according to claim 1, wherein
said radiator core support upper cover is formed with attachment holes to fix mounting pins of said heat exchanger, and provided on a bottom face thereof with sandwiching portions to sandwich and fix tongue pieces of said fan shroud portion in a forward and back ward direction thereof.
